(19) United States
(12) Patent Application Publication
(10) Pub. No.: US 2006/0208430 A1
(43) Pub. Date: Sep. 21, 2006

(54) Method for the production of a transport and assembly aid for rubber moulded seals and transport and assembly aid

(76) Inventors: Timo Malz, Gondelsheim (DE); Ralf Salameh, Gondelsheim (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 10/530,997

(22) PCT Filed: Aug. 20, 2003
(86) PCT No.: PCT/DE03/02765

§ 371 Date: Feb. 24, 2006

(30) Foreign Application Priority Data
Oct. 12, 2002 (DE) 102 47 726.4

(51) Int. Cl. F16J 15/02

(52) U.S. Cl. 277/637

(57) ABSTRACT

A ring seal assembly includes a rubber ring seal and a carrying frame which extends about a periphery of the ring seal. The carrying frame has mounting lugs which extend from the carrying frame and are embedded in the ring seal during molding of the seal. The ring seal can be handled and transported via the carrying frame and positioned for installation in a sealing end use application. The lugs are separable from the carrying frame with the application of a suitable braking force to enable selective detachment of the carrying frame from the ring seal.

The invention concerns a device that facilitates the transport and mounting of rubber ring seals.

DE-A 198 29 833 describes a device that facilitates the fastening of an elastic ring seal to one component of a machine assembly, around the rim of an opening in the component. According to DE-A 198 29 833, the ring seal is possessed of an adhesive surface that extends around at least part of its circumference, allowing the seal to be fastened to the rim of the opening in the component. A second component can then be snugly joined to the first thanks to the ring seal that has been inserted around the opening in the first. The mounting device is possessed of a base plate with a ridge. The footprint of the ridge conforms to the outline of the opening in the first component of the assembly. The footprint of the device's base plate, surrounding the footprint of the ridge, presents a negative image of the contact surface around the rim of the opening to which the seal is to be fastened. By means of this device, a ring seal with a circumferential adhesive surface can be centered and affixed to the opening with great positional accuracy. A mounting device of this kind, however, is not suitable for use with ring seals made of rubber.

DE 19845920 C1 shows a mounting device in the form of a mounting plate with injection bores used in creating the seal. After sealing material is injected, the seal is bound to the mounting plate by feed nipples. The seal and the mounting plate are introduced into the machine-component that is to be sealed. Then the mounting plate is detached from the seal, in the process of which the sealing material is torn off at the feed nipples. The disadvantage of this design is that burrs remain on the seal at the tear points. In addition, the seal may be damaged in the tearing process. A further disadvantage is that a so-called “feed spider” is formed on the upper surface of the metal plate. The size of the “feed spider” is proportional to that of the seal. After the device is separated from the seal, the “feed spider” must be disposed of at considerable expense. This raises the cost of production of the seal.

To obviate this problem, transport and mounting devices were created that gripped the seal at its periphery, outside its sensitive zone.

One such transport and mounting device is shown in DE 1984043. This filing shows a carrying frame that grips the seal at a groove in the side of the latter. The seal adheres to the frame thanks to contraction forces. This frame can only be used with a seal that forms a closed ring; otherwise the seal would fall off.

U.S. Pat. No. 5,577,314 shows a mounting device manufactured by injection techniques. It consists of injection material, not plastic or metal. In addition, the carrying frame is not attached to the seal, then detached from it.

Ring seals made of pure rubber are malleable. This means that rubber ring seals are rarely compatible with automated manufacturing or mounting processes. Moreover, rubber ring seals have to be restored to their correct position for any control or transport operations. This must be done again one last time when the seal is inserted in a groove on the premises of the final customer or system supplier.

The objective of the present invention is to stabilize rubber ring seals for transport and mounting purposes without significantly adding to costs. The aim is to make it possible to automate virtually the entire manufacturing, transport, and mounting process.

The present invention achieves this objective by virtue of the characteristics described under Patent claim 1. Advantageous further developments of the process proposed by the present invention are set forth in the relevant subordinate patent claims.

The basic principle of the present invention consists in suspending the rubber ring seal from a carrying frame and keeping it there throughout the manufacturing, testing and transport phases of its production. Another substantial advantage of this approach becomes clear in the mounting phase. That is when the rubber ring seal is detached from the frame.

The advantage is—depending on the type of carrying frame employed—that the latter can be made of re-usable or cheap material, such as wire, plastic, cardboard or other disposable material. The carrying frame is wrought locally at several places in proximity to the rubber ring seal. A sample realization of the concept of the present invention is illustrated in the drawing. The realization is described as follows:

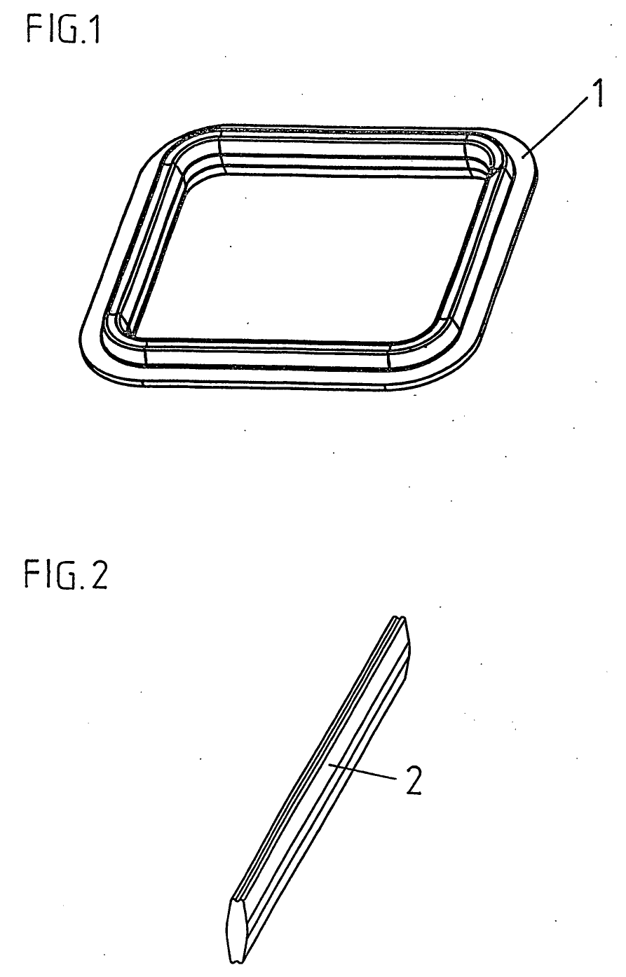

FIG. 1: schematic presentation of a closed carrying frame;

FIG. 2: section of a rubber ring seal whose cross-section is in the shape of an “I”

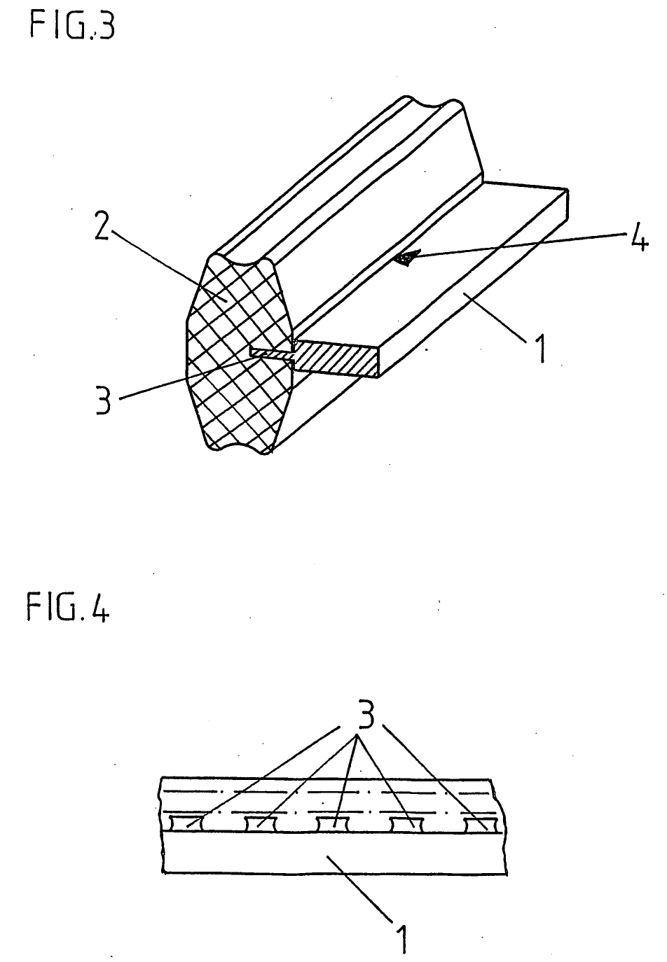

FIG. 3: combination of the carrying frame and the rubber ring seal

FIG. 4: highlighting of points of connection between the carrying frame and the rubber ring seal

FIG. 1 shows a rigid carrying frame (1) made of plastic in this example.

FIG. 2 shows a malleable rubber ring seal (2) whose cross-section is in the shape of an “I”.

FIG. 3 illustrates the situation after the emergence of the rubber ring seal from the injection machine. The rubber ring seal (2), the carrying frame (1), and a single connection lug (3) are visible. In this situation, the rubber ring seal—the form of which is now stabilized—can be handled without problems as it passes through the remaining manufacturing and transport phases of its production. A peripheral area that is in contact with the carrying frame (1) is visible. Depending on the specific design of the rubber ring seal (2), the carrying frame (1) can be attached at either the inner or the outer peripheral areas (4).

FIG. 4 illustrates several of the connection lugs (3) of which one is visible in FIG. 3. For mounting purposes, the carrying frame (1) is snapped off at the intended break points represented by the connection lugs (3), and can then be reused if needed.

FIG. 1 shows a rigid carrying frame (1) made of plastic in this example.

FIG. 2 shows a malleable rubber ring seal (2) whose cross-section is in the shape of an “I”.

FIG. 3 illustrates the situation after the emergence of the rubber ring seal from the injection machine. The rubber ring seal (2), the carrying frame (1), and a single connection lug (3) are visible. In this situation, the rubber ring seal—the form of which is now stabilized—can be handled without problems as it passes through the remaining manufacturing and transport phases of its production. A peripheral area that is in contact with the carrying frame (1) is visible. Depending on the specific design of the rubber ring seal (2), the carrying frame (1) can be attached at either the inner or the outer peripheral areas (4).

FIG. 4 illustrates several of the connection lugs (3) of which one is visible in FIG. 3. For mounting purposes, the carrying frame (1) is snapped off at the intended break points represented by the connection lugs (3), and can then be reused if needed.

1-3. (canceled)

4. A ring seal assembly, comprising:
a rubber ring seal having a periphery;
a carrying frame extending about the periphery of said ring seal and including a plurality of mounting lugs extending from said carrying frame into said ring seal and being separable from said carrying frame so that said carrying frame can be selectively detached from said ring seal.

5. The ring seal assembly of claim 4, wherein said carrying frame is made of re-usable plastics or metal material.

6. The ring seal assembly of claim 4, wherein said carrying frame is disposable.

7. The ring seal assembly of claim 4, wherein said carrying frame is fabricated of a material selected from the group consisting of: wire, plastic or cardboard.

8. The ring seal assembly of claim 4, wherein said ring seal is molded about said mounting lugs.

9. The ring seal assembly of claim 4, wherein the carrying frame is fabricated form a material different than that used to make said ring seal.
